(19) United States
(12) Patent Application Publication
(10) Pub. No.: US 2024/0426057 A1
(43) Pub. Date: Dec. 26, 2024

(54) POROUS CARBON PAPER AND MANUFACTURING METHOD THEREOF

(71) Applicant: KOREA ADVANCED INSTITUTE OF SCIENCE AND TECHNOLOGY, Daejeon (KR)

(72) Inventors: Jae Woo LEE, Daejeon (KR); WonChan YUN, Daejeon (KR); Dayeon LEE, Daejeon (KR); Jeong Woo YANG, Daejeon (KR)

(21) Appl. No.: 18/748,223

(22) Filed: Jun. 20, 2024

(30) Foreign Application Priority Data
Jun. 20, 2023 (KR) 10-2023-0078832

(51) Int. Cl. D21H 13/50; C01B 32/166; D01D 5/00; H01M 4/02; H01M 4/62

(52) U.S. Cl. CPC D21H 13/50; C01B 32/166; H01M 4/628; D01D 5/0007; D10B 2101/12; D10B 2505/00; H01M 2004/028

(57) ABSTRACT

The present invention relates to a porous carbon paper and a method for preparing the same, and more particularly to a porous carbon paper having high surface area and pore volume, containing both micropores (<2 nm) and mesopores (2-50 nm), and having a structure with carbon nanotubes grown on carbon nanofibers, and a method for preparing the same.

### TECHNICAL FIELD

The present invention relates to a porous carbon paper and a method for preparing the same, and more particularly to a porous carbon paper having high surface area and pore volume, containing both micropores (<2 nm) and mesopores (2-50 nm), and having a structure with carbon nanotubes grown on carbon nanofibers, and a method for preparing the same.

### RELATED ART

As the amount of carbon dioxide, the greenhouse gas responsible for global warming, continues to increase, commercial energy storage devices that can be used without the emission of carbon dioxide gas, such as lithium-ion batteries and supercapacitors, have been developed over the past few decades. However, due to their limited energy storage capacity, these devices are mainly used for low-capacity mobile devices such as cell phones, which limits the application of energy storage devices that require high energy density.

Lithium-sulfur batteries have attracted a lot of attention recently because they have a high theoretical energy density (2600 Wh/kg), which overcomes the disadvantages of the aforementioned energy storage devices and can be applied to systems requiring high storage energy. During the charging/discharging process of lithium-sulfur batteries, sulfur-based materials at the positive electrode are converted from solid to liquid phase or from liquid to solid phase, and during this process, the sulfides converted to liquid phase migrate to the lithium electrode at the opposite negative electrode, causing self-discharge, resulting in a shuttle phenomenon that causes a large loss of capacity. In addition, sulfides converted to the solid phase have a slower conversion rate compared to liquid sulfides, so the reaction cannot occur effectively at high current densities, and in the case of solid sulfides that are not uniformly distributed, they cannot be utilized in the subsequent charge/discharge process, resulting in irreversible capacity loss.

Recently, in order to solve this problem, attempts have been made to minimize the shuttle phenomenon by doping heteroatoms such as nitrogen (N), oxygen (O), and boron (B), and forming strong chemical interactions with sulfides. In addition, research is also underway to physically mitigate the shuttle phenomenon by introducing an additional layer between the positive electrode and the separator called an interlayer as well as changing the surface properties of the material. Korean Patent No. 10-2120057 discloses that a separator in the shape of graphite felt formed by electrospinning is placed between the positive electrode and the separator of a Li—S battery, and lithium polysulfide generated during charge and discharge can be physically and chemically adsorbed on the separator, thereby preventing the shuttle phenomenon. These various attempts to mitigate the shuttle phenomenon are increasingly improving the capacity of Li—S batteries. However, most of the existing research involves methods of manufacturing a slurry-based electrode, which use conductive materials, binders, and electrolytes that cannot contribute to the absolute capacity, reducing the proportion of active materials that contribute to the effective capacity, and ultimately reducing the effective capacity significantly.

Accordingly, the present inventors have made diligent efforts to solve the above problems, and as a self-supporting electrode material that does not use additional materials such as binders, conductive materials, and current collectors, the present inventors have prepared a porous carbon paper with a structure of carbon nanotubes grown on carbon nanofibers, containing both micropores (<2 nm) and mesopores (2-50 nm), having high surface area and pore volume, applied it as a positive electrode material for a Li—S battery, and have found that it exhibits excellent electrochemical performance, and have completed the present invention.

### DETAILED DESCRIPTION OF THE INVENTION

### Technical Problem

It is an object of the present invention to provide a carbon paper having high surface area and pore volume, and a method for producing the same, in order to increase the ratio and utilization of active materials in a Li—S battery.

Another object of the present invention is to provide a positive electrode for a Li—S battery comprising the carbon paper.

### Technical Solution

To achieve the above objects, the present invention provides a method for producing an inert gas-induced porous carbon paper, comprising: electrospinning a mixture of a polymeric matrix, a transition metal or a transition metal oxide, and a transition metal acetylacetonate dispersed therein to obtain carbon nanofibers; and reacting the obtained carbon nanofibers at 600° C. to 1000° C. under a bubbling process between an inert gas and an isopropyl alcohol solution to obtain a carbon paper having a structure comprising both micropores (<2 nm) and mesopores (2-50 nm), and having carbon nanotubes grown on the carbon nanofibers.

The present invention also provides an inert gas-induced porous carbon paper having a surface area of 100-500 m²/g and a pore volume of 0.2-0.8 cm³/g.

The present invention also provides a positive electrode for a Li—S battery comprising the inert gas-induced porous carbon paper, and having a discharge capacity of 300 to 900 mAh/g for 100 cycles at 1.7 to 2.8 V and 0.2 to 2.0 C operating conditions.

The present invention provides a method for preparing a carbon dioxide gas-induced porous carbon paper, comprising: electrospinning a mixture of a polymeric matrix, a transition metal or transition metal oxide, and a transition metal acetylacetonate dispersed therein to obtain carbon nanofibers; and reacting the obtained carbon nanofibers at 600° C. to 1000° C. under a bubbling process between a carbon dioxide gas and an isopropyl alcohol solution dispersed with boron hydride to obtain a carbon paper having a structure with carbon nanotubes grown on the carbon nanofibers, and containing both micropores (<2 nm) and mesopores (2-50 nm).

The present invention also provides a carbon dioxide gas-induced porous carbon paper having a surface area of 200-600 m²/g and a pore volume of 0.3-1.0 cm³/g.

The present invention also provides a positive electrode for a Li—S battery comprising the carbon dioxide gas-induced porous carbon paper, and having a discharge capacity of 500 to 1000 mAh/g for 100 cycles at 1.7 to 2.8 V and 0.2 to 2.0 C operating conditions.

### Advantageous Effect

The porous carbon paper prepared according to the present invention has a structure in which carbon nanotubes are grown on carbon nanofibers, wherein the transition metal precursor of the present invention forms many pores in the carbon nanofiber region and acts as a catalyst for growing carbon nanotubes on carbon nanofibers, so that a porous carbon paper having high surface area and pore volume, and both micropores (<2 nm) and mesopores (2-50 nm) can be prepared.

In addition, the carbon dioxide gas used in the bubbling process is used as a precursor to generate additional carbon nanotubes, so that the carbon dioxide gas-induced porous carbon paper can have higher surface area and pore characteristics than other materials. Therefore, when the porous carbon paper is used as a positive electrode material for a Li—S battery, the active material, sulfide, is sufficiently impregnated in the pores for effective distribution, and the ratio of pyridinic nitrogen and pyrrolic nitrogen, which can form strong chemical interactions with the active material, is high, which can maximize the oxidation and reduction reactions at the interface.

Furthermore, since the porous carbon paper prepared according to the present invention does not require additional binders, conductive materials, and current collectors, the proportion of active material can be increased, thereby improving the substantial electrochemical capacity and energy density rather than the apparent capacity.

As a result, the present invention is an economical and efficient process as it uses inexpensive raw materials such as carbon dioxide and can be manufactured through a single thermal treatment process. Simultaneously, it synthesizes a porous carbon paper with edge nitrogen atoms introduced to enhance electrochemical properties. Therefore, it achieves both effective application in the high value-added next-generation secondary battery industry and contributes to carbon dioxide reduction and utilization.

### BRIEF DESCRIPTION OF DRAWINGS

FIG. 1 is SEM and TEM photographs of a non-porous carbon nanofiber for self-supporting electrodes (FsNPCNF) obtained in Example 1 of the present invention.

FIG. 2 shows SEM and TEM photographs of a carbon nanofiber with inert gas-induced carbon nanotubes (CNT/FsEPCNF) for self-supporting electrodes obtained in Example 2 of the present invention.

FIG. 3 shows SEM and TEM photographs of a carbon nanofiber with carbon dioxide gas-induced carbon nanotubes (CCNT/FsEPCNF) for self-supporting electrodes obtained via a polyacrylonitrile polymer matrix in Example 3 of the present invention.

FIG. 4 is an SEM photograph of a carbon nanofiber with carbon dioxide gas-induced carbon nanotubes (CCNT/FsEPCNF) for self-supporting electrodes obtained via a polyvinylpyrrolidone polymer matrix in Example 3 of the present invention.

FIG. 5 shows the XRD analysis results of the materials obtained in Examples 1, 2 and 3 of the present invention.

FIG. 6 shows the results of Raman analysis of materials obtained in Examples 1, 2 and 3 of the present invention.

FIG. 7 shows the results of nitrogen adsorption isotherm curve analysis of the materials obtained in Examples 1, 2 and 3 of the present invention.

FIG. 8 shows the results of the pore distribution analysis of the materials obtained in Examples 1, 2 and 3 of the present invention.

FIG. 9 is a nitrogen atom XPS graph of a non-porous carbon nanofiber (FsNPCNF) for self-supporting electrodes obtained in Example 1 of the present invention.

FIG. 10 is a nitrogen atom XPS graph of a carbon nanofiber with inert gas-induced carbon nanotubes (CNT/FsEPCNF) for self-supporting electrodes obtained in Example 2 of the present invention.

FIG. 11 is a nitrogen atom XPS graph of a carbon nanofiber with carbon dioxide gas-induced carbon nanotubes (CCNT/FsEPCNF) for self-supporting electrodes obtained in Example 3 of the present invention.

FIG. 12 shows a graph of cyclic voltammetry (CV) performed at different voltage scan rates, utilizing a non-porous carbon nanofiber (FsNPCNF) material for self-supporting electrodes obtained in Example 1 of the present invention as a positive electrode of a Li—S battery.

FIG. 13 shows a graph of cyclic voltammetry performed at different voltage scan rates, utilizing a carbon nanofiber material with inert gas-induced carbon nanotubes (CNT/FsEPCNF) for self-supporting electrodes obtained in Example 2 of the present invention as a positive electrode of a Li—S battery.

FIG. 14 shows a graph of cyclic voltammetry performed at different voltage scan rates, utilizing a carbon nanofiber material with carbon dioxide gas-induced carbon nanotubes (CCNT/FsEPCNF) for self-supporting electrodes obtained in Example 3 of the present invention as a positive electrode of a Li—S battery.

FIG. 15 is a graph showing the rate capability characteristics when utilizing a non-porous carbon nanofiber (FsNPCNF) material for self-supporting electrodes obtained in Example 1 of the present invention as a positive electrode of a Li—S battery, when operated at different current densities (0.2 to 2.0).

FIG. 16 is a graph showing the rate capability characteristics when utilizing a carbon nanofiber material with inert gas-induced carbon nanotubes (CNT/FsEPCNF) for self-supporting electrodes obtained in Example 2 of the present invention as a positive electrode of a Li—S battery, when operated at different current densities (0.2 to 2.0).

FIG. 17 is a graph showing the rate capability characteristics when utilizing a carbon nanofiber material with carbon dioxide gas-induced carbon nanotubes (CCNT/FsEPCNF) for self-supporting electrodes obtained in Example 3 of the present invention as a positive electrode of a Li—S battery, when operated at different current densities (0.2 to 2.0).

FIG. 18 is a graph showing the charge and discharge cycle capacities obtained at a current density of 0.2 C, utilizing a non-porous carbon nanofiber (FsNPCNF) material for self-supporting electrodes obtained in Example 1 of the present invention as a positive electrode of a Li—S battery.

FIG. 19 is a graph showing the charge and discharge cycle capacities obtained at a current density of 0.2 C, utilizing a carbon nanofiber material with inert gas-induced carbon nanotubes (CNT/FsEPCNF) for self-supporting electrodes obtained in Example 2 of the present invention as a positive electrode of a Li—S battery.

FIG. 20 is a graph showing the charge and discharge cycle capacities obtained at a current density of 0.2 C, utilizing a carbon nanofiber material with carbon dioxide gas-induced carbon nanotubes (CCNT/FsEPCNF) for self-supporting electrodes obtained through a polyacrylonitrile polymer matrix in Example 3 of the present invention as a positive electrode of a Li—S battery.

FIG. 21 is a graph showing the charge and discharge cycle capacities obtained at a current density of 0.2 C, utilizing a carbon nanofiber material with carbon dioxide gas-induced carbon nanotubes (CCNT/FsEPCNF) for self-supporting electrodes obtained through a polyvinylpyrrolidone polymer matrix in Example 3 of the present invention as a positive electrode of a Li—S battery.

FIG. 22 is a graph showing the charge and discharge cycle capacities obtained at a current density of 2.0 C, utilizing a carbon nanofiber material with carbon dioxide gas-induced carbon nanotubes (CCNT/FsEPCNF) for self-supporting electrodes obtained in Example 3 of the present invention as a positive electrode of a Li—S battery.

FIG. 23 is a graph showing the charge and discharge cycle capacities obtained by driving a cell with a high content of active material of 6.52 mg/cm², utilizing a carbon nanofiber material with carbon dioxide gas-induced carbon nanotubes (CCNT/FsEPCNF) for self-supporting electrodes obtained in Example 3 of the present invention as a positive electrode of a Li—S battery.

FIG. 24 is a graph showing the cycle capacities obtained in Example 3 of the present invention converted to the deliverable capacity per total weight for a cell driven with a high content of active material of 6.52 mg/cm², utilizing a carbon nanofiber material with carbon dioxide gas-induced carbon nanotubes (CCNT/FsEPCNF) for self-supporting electrodes as a positive electrode of a Li—S battery.

### DETAILED DESCRIPTION OF THE INVENTION

Unless otherwise defined, all technical and scientific terms used herein have the same meaning as commonly understood by a person skilled in the art. In general, the nomenclature used herein is well known and in common use in the art.

While research is underway to dope elemental species or introduce interlayers between the positive electrode and separator to mitigate the shuttle phenomenon in Li—S batteries, most electrodes are manufactured on a slurry basis, which reduces the proportion of active material contributing to the effective capacity due to the inclusion of conductive materials, binders, and current collector materials that cannot contribute to the absolute capacity, and ultimately reduces the practical specific capacity significantly.

In the present invention, a material for self-supporting electrodes that does not utilize additional materials such as binders, conductive materials, and current collectors is prepared, wherein the material utilizes a template that forms pores and a material that acts as a catalyst for the growth of carbon nanotubes, and it is confirmed that application to a Li—S battery of a porous carbon nanofiber with carbon nanotubes for self-supporting electrodes which form additional pores and have a larger surface area due to the deposition of gases from an inert gas-induced bubbling process can increase the proportion of active material, thereby improving the substantial electrochemical capacity and energy density, rather than the apparent capacity.

Accordingly, in one aspect, the present invention provides a method for preparing a carbon dioxide gas-induced porous carbon paper, comprising: electrospinning a mixture of a polymeric matrix, a transition metal or transition metal oxide, and a transition metal acetylacetonate dispersed therein to obtain carbon nanofibers; and reacting the obtained carbon nanofibers at 600° C. to 1000° C. under a bubbling process between a carbon dioxide gas and an isopropyl alcohol solution dispersed with boron hydride to obtain a carbon paper having a structure with carbon nanotubes grown on the carbon nanofibers, and containing both micropores (<2 nm) and mesopores (2-50 nm).

The present invention relates, in another aspect, to an inert gas-induced porous carbon paper having a surface area of 100-500 m²/g and a pore volume of 0.2-0.8 cm³/g.

In another aspect, the present invention relates to a positive electrode for a Li—S battery comprising an inert gas-induced porous carbon paper and having a discharge capacity of 300 to 900 mAh/g for 100 cycles at drive conditions of 1.7 to 2.8 V and 0.2 to 2.0 C.

Furthermore, the present invention found that induction of carbon dioxide gas instead of inert gas caused the carbon nanotubes to grow into an intertwined structure, and that the intertwined structure of the carbon nanotubes included additional pores, providing an expanded reaction active site. At the same time, additional chemical gases were generated by the reaction of boron hydride-derived gas and carbon dioxide, and these gases were deposited on the transition metal catalyst to grow into intertwined carbon nanotubes. It was also found that the excellent pore structure can provide sufficient space for sulfide impregnation, which can increase the active material ratio through the utilization of a large amount of active material, thereby further improving the actual electrochemical capacity and energy density rather than the apparent capacity.

Accordingly, in another aspect, the present invention provides a method for preparing a carbon dioxide gas-induced porous carbon paper, comprising: electrospinning a mixture of a polymeric matrix, a transition metal or transition metal oxide, and a transition metal acetylacetonate dispersed therein to obtain carbon nanofibers; and reacting the obtained carbon nanofibers at 600° C. to 1000° C. under a bubbling process between a carbon dioxide gas and an isopropyl alcohol solution dispersed with boron hydride to obtain a carbon paper having a structure with carbon nanotubes grown on the carbon nanofibers, and containing both micropores (<2 nm) and mesopores (2-50 nm).

In another aspect, the present invention relates to a carbon dioxide gas-induced porous carbon paper having a surface area of 200-600 m²/g and a pore volume of 0.3-1.0 cm³/g.

In another aspect, the present invention relates to a positive electrode for a Li—S battery comprising a carbon dioxide gas-induced porous carbon paper and having a discharge capacity of 500 to 1000 mAh/g for 100 cycles at operating conditions of 1.7 to 2.8 V and 0.2 to 2.0 C.

The present invention will be described in more detail below.

The polymeric matrix precursors used in the present invention may be polymers soluble in organic solvents, such as polyacrylonitrile (PAN), polyvinylpyrrolidone (PVP), polyvinylidene fluoride (PVDF), and the like. A mixture of two or more of the above polymers can also be used.

The hydrogen precursors used in the present invention include hydrogen (H₂), hydrogen gas mixture or boron hydride. The boron hydride may be an alkali metal or an alkaline metal boron hydride, more particularly sodium boron hydride (NaBH₄), lithium boron hydride (LiBH₄), magnesium boron hydride (Mg(BH₄)₂), strontium boron hydride (Sr(BH₄)₂), potassium boron hydride (KBH₄), calcium boron hydride ((Ca(BH₄)₂), and the like. A mixture of two or more of the above may also be used.

The heat treatment process may be performed at an absolute pressure of 0.01 to 10 atmospheres, preferably 0.05 to 5.0 atmospheres.

The temperature of the initial warming process using the argon gas is predicted to be preferably 500° C. or higher, and a temperature of 600° C. or higher may be required to sufficiently carbonize the carbon nanofibers.

In the heat treatment process, the temperature may be increased at a rate of 1 to 20° C./min, preferably 1 to 10° C./min.

The gases utilized to cause the bubbling of isopropyl alcohol solution during the late heat treatment may be argon gas and carbon dioxide gas.

The temperature of the late isopropyl alcohol solution bubbling process utilizing the argon gas and carbon dioxide gas is predicted to be preferably 600° C. or more, and the temperature of 700° C. or more may be required for more effective growth of carbon nanotubes.

Preferably, the reaction time for the late isopropyl alcohol solution bubbling process utilizing the argon gas and carbon dioxide gas is 30 minutes to 120 minutes. More preferably, it is predicted to be at least 30 minutes, and a reaction time of at least 60 minutes may be required for more effective growth of carbon nanotubes.

The pore-forming template and carbon nanotube growth catalyst used in the above heat treatment process may be a transition metal or a transition metal oxide, and more specifically, the transition metal may be nickel (Ni), cobalt (Co), iron (Fe), or molybdenum (Mo). Furthermore, a single species or a mixture of two or more of the above may be used.

The pore formation template and carbon nanotube growth catalyst mentioned above may be any of the transition metal oxides mentioned above (MetalₓO_{y}). The transition metal oxides may be, for example, NiO, Ni₂O₃, Ni₃O₄, CoO, CO₂O₃, CO₃O₄, FeO, Fe₂O₃, Fe₃O₄, MoO₂, MoO₃, and the like. However, the present invention is not limited to these examples and any other form of transition metal oxide, including the metals mentioned above, may be used.

The carbon nanotube growth catalyst used in the above heat treatment process may be a transition metal acetylacetonate, more specifically nickel acetylacetonate, cobalt acetylacetonate, iron acetylacetonate, or molybdenum acetylacetonate. Furthermore, a single species or a mixture of two or more of the above may be used.

Furthermore, the method for the preparation of carbon nanofibers with the carbon nanotubes for the self-supporting electrodes of the present invention includes the step of releasing a gas to a polymeric matrix with a transition metal base material that serves as a pore-forming template and a carbon nanotube growth catalyst under moderate pressure and reacting it. Specifically, a heat treatment process with bubbling by introducing an inert gas or carbon dioxide to an isopropyl alcohol solution dispersed with a boron hydride, a hydrogen precursor, could be performed at a temperature of 200 to 1000° C.

Hereinafter, the present invention will be described in more detail by examples for better understanding, but the following examples are only illustrative of the present invention, and it will be obvious to those of ordinary skill in the art that various changes and modifications are possible within the scope and technical idea of the present invention, and that such changes and modifications fall within the scope of the appended patent claims.

### Example 1: Preparation of a Non-Porous Carbon Nanofiber (FsENPCNF) for Self-Supporting Electrodes

A method for preparing FsENPCNF, a non-porous carbon nanofiber material for free-standing electrodes without pore-forming templates and carbon nanotube growth catalysts, is described in detail as follows.

1.0 g of polyacrylonitrile (PAN, M_{w}=150,000, Sigma-Aldrich) or polyvinylpyrrolidone (PVP, M_{w}=360,000, Sigma-Aldrich) was completely dissolved in 10.6 mL of dimethylformamide (DMF, >99.8%, Sigma-Aldrich) solution for at least 12 hours. 9 mL of the solution was then electrospun at a rate of 1 mL/hour at 15.5 kV, followed by drying at 100° C. for 24 hours to remove solvent. After all solvent was removed, the fibers were placed in a furnace and heat treated with air gas (Air, Sam-O gas) and argon gas (Ar>99.999%, Sam-O gas) flowing at 60 ml/min. Initially, the temperature was raised from 25° C. to 280° C. at a warming rate of 1° C./min with air and held for 1 hour. The temperature was then raised from 280° C. to 800° C. with argon gas flowing at 5° C./min. The temperature was then maintained at 800° C. for 6 hours. After the reactor cooled down, it was washed with 5 M hydrochloric acid, hot water, cold water, and ethanol until it became neutral to remove produced by-products, and the precipitate was dried in an oven at 1 atm and 100° C. for 24 hours to obtain a non-porous carbon nanofiber (FsENPCNF) for self-supporting electrodes.

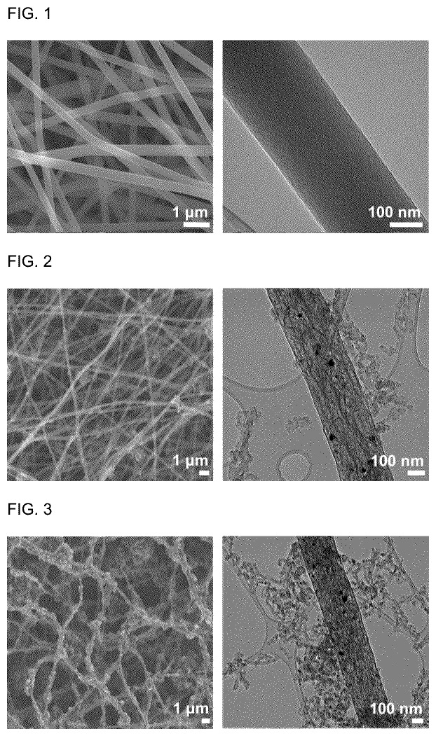

SEM and TEM analysis of the non-porous carbon nanofiber (FsENPCNF) prepared in Example 1 showed that they are completely void-free, as shown in FIG. 1. This can be confirmed that since there is no any additional chemical other than polyacrylonitrile, air and argon alone cannot synthesize a template to expand the internal space, no pores are made on the both of outside and inside.

### Example 2: Preparation of a Carbon Nanofiber with Inert Gas-Induced Carbon Nanotubes (CNTs/FsEPCNF) for Self-Supporting Electrodes

A method for preparing CNT/FsEPCNF, a porous carbon nanofiber material with a structure with a grown carbon nanotube for free-standing electrodes, by homogeneously mixing nickel oxide and nickel acetylacetonate, transition metal precursors that act as pore templates and carbon nanotube growth catalysts, in a dimethylformamide solution containing polyacrylonitrile, polyvinylpyrrolidone, or polyvinylidene fluoride, is described in detail as follows.

0.75 g of polyacrylonitrile (PAN, M_{w}=150,000, Sigma-Aldrich) or polyvinylpyrrolidone (PVP, M_{w}=360,000, Sigma-Aldrich) was dissolved in 8 mL of dimethylformamide (DMF, >99.8%, Sigma-Aldrich) solution for at least 12 hours, and nickel oxide (NiO, >99%, Sigma-Aldrich, particle size>50 nm) among the above mentioned transition metal oxides, and nickel acetylacetonate (>96%, Alfa Aesar) among transition metal oxide acetylacetonate were added at 0.3 g and 0.075 g, respectively, and mixed for 12 hours. Then 5 mL of the solution was electrospun at a rate of 1.2 mL/hour at a voltage of 15.5 kV. After electrospinning, the solution was dried at 100° C. for 24 hours to remove the solvent. After all solvents were removed, the fibers were placed in the reactor and purged with argon gas (Ar>99.999%, Sam-O gas) flowing at 60 ml/min. The reactor temperature was then raised from 25° C. to 700° C. under argon condition at 5° C./min. Before reaching 700° C., isopropyl alcohol (IPA, >99.5, Sigma-Aldrich) was placed in a chamber that had both an inlet for the carrier gas argon to continuously enter and form bubbles in the solution, and an outlet for the carrier gas to bubble out and continuously enter the reactor. When reaching 700° C., an argon gas line flowing at 30 to 120 ml/min was connected to the inlet of the chamber containing the isopropyl alcohol, and the outlet of the chamber was connected to the reactor. After the above process was maintained at 700° C. for a certain period, argon gas was flowed into the reactor at 60 ml/min until the reactor was cooled down. After the reactor was cooled down, it was washed with 5 M hydrochloric acid, hot water, cold water, and ethanol until it became neutral to remove produced by-products, and the precipitate was dried in an oven at 1 atm and 100° C. for 24 hours to obtain a carbon nanofiber with inert gas-induced carbon nanotubes (CNT/FsEPCNF) for self-supporting electrodes.

SEM and TEM analysis of the carbon nanofiber with inert gas-induced carbon nanotubes (CNT/FsEPCNF) for self-supporting electrodes prepared in Example 2 show that the carbon nanofibers have pores and at the same time carbon nanotubes have grown on the outer surface, as shown in FIG. 2. This indicates that the transition metal precursor, nickel oxide, formed pores inside the carbon nanofibers and improved the pore properties, and acted as a catalyst to grow carbon nanotubes outside of the carbon nanofibers together with nickel acetylacetonate.

### Example 3: Preparation of a Carbon Nanofiber with Carbon Dioxide Gas-Induced Carbon Nanotubes (CCNT/FsEPCNF) for Self-Supporting Electrodes

A method for preparing CCNT/FsEPCNF, a porous carbon nanofiber material for free-standing electrodes, with a structure having a grown carbon nanotube derived from carbon dioxide gas (CO₂-derived) by homogeneously mixing nickel oxide and nickel acetylacetonate, transition metal precursors that act as pore templates and carbon nanotube growth catalysts, in a dimethylformamide solution containing polyacrylonitrile, polyvinylpyrrolidone, or polyvinylidene fluoride, is described in detail as follows.

0.75 g of polyacrylonitrile (PAN, M_{w}=150,000, Sigma-Aldrich) or polyvinylpyrrolidone (PVP, M_{w}=360,000, Sigma-Aldrich) was dissolved in 8 mL of dimethylformamide (DMF, >99.8%, Sigma-Aldrich) for at least 12 hours, and nickel oxide (NiO, >99%, Sigma-Aldrich, particle size>50 nm) among the above mentioned transition metal oxides, and nickel acetylacetonate (>96%, Alfa Aesar) among transition metal oxide acetylacetonate were added at 0.3 g and 0.075 g, respectively, and mixed for 12 hours. Then 5 mL of the solution was electrospun at a rate of 1.2 mL/hour at a voltage of 15.5 kV. After electrospinning, the solution was dried at 100° C. for 24 hours to remove the solvent. After all solvents were removed, the fibers were placed in the reactor and purged argon gas (Ar>99.999%, Sam-O gas) flowing at 60 ml/min. The reactor temperature was then raised from 25° C. to 700° C. under argon condition at 5° C./min. Before reaching 700° C., isopropyl alcohol (IPA, >99.5, Sigma-Aldrich) dispersed with 4 g of sodium boron hydride (NaBH₄, >96%, Sigma-Aldrich) among the above mentioned boron hydride was prepared. The isopropyl alcohol solution dispersed with sodium boron hydride was placed in a chamber that had both an inlet for the carrier gas argon to continuously enter and form bubbles in the solution, and an outlet for the carrier gas to bubble out and continuously enter the reactor. When reaching 700° C., a carbon dioxide line flowing at 30 to 120 ml/min was linked to the inlet of the chamber containing the isopropyl alcohol dispersed with sodium boron hydride, and the outlet of the chamber was connected to the reactor. The above process was maintained at 700° C. for certain period, and then argon gas was flowed into the reactor at 60 ml/min until the reactor was cooled down. After the reactor was cooled down, it was washed with 5 M hydrochloric acid, hot water, cold water, and ethanol until it became neutral to remove produced by-products, and the precipitate was dried in an oven at 1 atm and 100° C. for 24 hours to obtain a carbon nanofiber with carbon dioxide gas-induced carbon nanotubes (CCNT/FsEPCNF) for self-supporting electrodes.

SEM and TEM analysis of carbon nanofiber with carbon dioxide gas-induced carbon nanotubes (CCNT/FsEPCNF) for self-supporting electrodes prepared in Example 3 show that the carbon nanofibers have pores and at the same time carbon nanotubes have grown on the outer surface of carbon nanofibers, as shown in FIG. 3. It was found that the nickel oxide enhanced the structural properties by forming pores inside the carbon nanofibers, and it acted as a catalyst for the growth of carbon nanotubes outside of the carbon nanofibers together with nickel acetylacetonate. Furthermore, it was observed that a higher density of carbon nanotubes had grown when carbon dioxide was utilized as a carrier gas compared to the inert gas (argon) treatment, indicating that carbon dioxide was utilized as a precursor for the growth of carbon nanotubes.

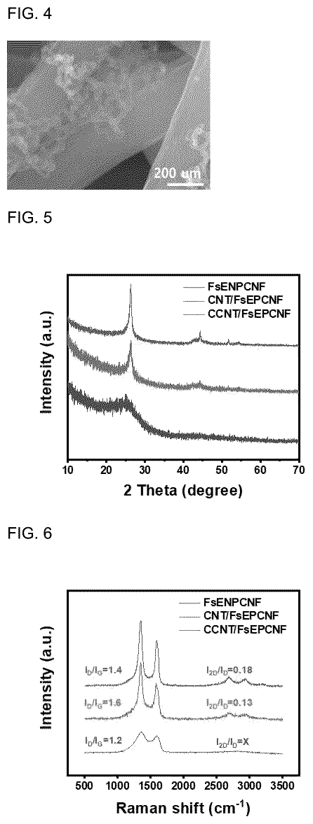

The SEM analysis of a carbon nanofiber with carbon dioxide gas-induced carbon nanotubes (CCNT/FsEPCNF) for self-supporting electrodes prepared by adding polyvinylpyrrolidone as a polymer matrix precursor in Example 3 shows that the carbon nanofibers have pores and at the same time carbon nanotubes have grown on the outer surface, as shown in FIG. 4.

The XRD analysis of the materials prepared in Examples 1, 2 and 3, as shown in FIG. 5, shows that FsENPCNF not prepared by the bubbling method has no obvious peaks in the XRD results, indicating that carbon nanofibers are amorphous materials. However, CNT/FsEPCNF synthesized by the bubbling process of isopropyl alcohol has carbon nanotubes grown from the surface in addition to carbon nanofibers, and the XRD results also show high peaks. This indicates that the carbon nanotubes are crystalline materials. Most notably, CCNT/FsEPCNF synthesized by flowing carbon dioxide gas to isopropyl alcohol dispersed with sodium boron hydride has much higher XRD crystal peaks than the other two materials, which can be interpreted as a result of the much higher density of carbon nanotubes grown on the outer surface compared to CNT/FsEPCNF.

The Raman analysis of the materials prepared in Examples 1, 2 and 3 shows that CNT/FsEPCNF has a much higher I_{D}/I_{G} ratio compared to FsENPCNF, as shown in FIG. 6. This is because the NiO generating pores in the carbon nanofibers has formed numerous defects inside the carbon nanofibers in addition to pores. Also, in terms of the I_{2D}/I_{D} ratio, it is impossible to determine the ratio because the 2D peak does not appear in FsENPCNF, whereas the 2D peak is formed in CNT/FsEPCNF, so it is confirmed that the I_{2D}/I_{G} ratio is 0.13. The I_{2D} peak is related to the growth of carbon nanotubes, and it can be interpreted that CNT/FsEPCNF has carbon nanotubes. CCNT/FsEPCNF has a lower I_{D}/I_{G} ratio compared to CNT/FsEPCNF. This is related to the increased I_{G} peak due to the production of more crystalline carbon nanotubes. Furthermore, the I_{2D}/I_{g} ratio has the highest value of 0.18, which can be interpreted that carbon dioxide gas was utilized as a carbon precursor to form a larger amount of crystalline carbon nanotubes.

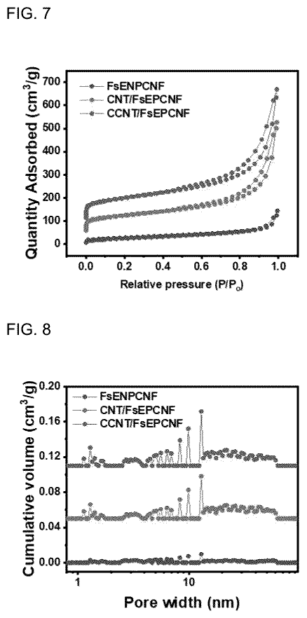

The BET analysis of the materials prepared in Examples 1, 2 and 3 shows that FsENPCNF without any transition metal precursors has a surface area of 69 m²/g and a pore volume of 0.191 cm³/g, as shown in FIG. 7. Moreover, CNT/FsEPCNF with transition metal precursors has a higher surface area of 262 m²/g and a pore volume of 0.706 cm³/g. This can be attributed to the transition metal oxide, NiO, acting as a template to form pores inside the carbon nanofibers. In addition, CCNT/FsEPCNF had the highest surface area of 324 m²/g and a pore volume of 0.826 cm³/g, and it can be attributed to the fact that the carbon nanotubes, made more abundant through carbon dioxide gas conversion, intertwined with each other to form additional pores and surface area. Therefore, it can be seen that carbon dioxide contributed significantly to the improvement of surface area and pore volume.

The analysis of the distribution of pore volumes of the materials prepared in Examples 1, 2 and 3 exhibits that, as shown in FIG. 8, the distribution of pores in the case of all materials shows a coexistence of micropore (<2 nm) regions and mesopores (2 nm<pore size<50 nm). However, for FsENPCNF, the absolute number of micropores and mesopores is not high. In contrast, CNT/FsEPCNF and CCNT/FsEPCNF had abundant micropores and mesopores, and it can be interpreted that CCNT/FsEPCNF may have a higher content of mesopores due to the intertwined carbon nanotubes.

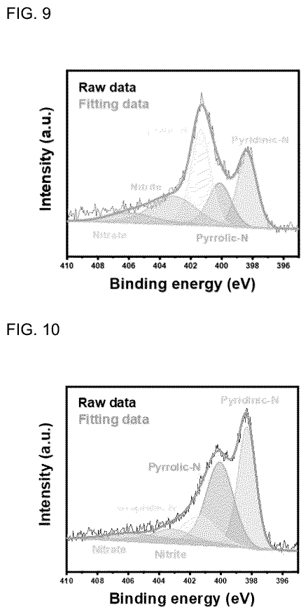

Nitrogen atom XPS analysis of the material prepared in Example 1 showed that FsENPCNF without the transition metal precursor mainly had pyridinic-N (0.90 at. %), pyrrolic-N (0.59 at. %), and graphitic-N (1.52 at. %), as shown in FIG. 9, with graphitic-N being numerically the most abundant. In general, graphitic-N is interpreted as a nitrogen atom species that is located in the center of the carbon rather than at the edges.

Nitrogen atom XPS analysis of the material prepared in Example 2 showed that the CNT/FsEPCNF prepared by the introduction of transition metal precursors and argon gas treatment had mainly pyridinic-N (3.18 at. %), pyrrolic-N (3.10 at. %), and graphitic-N (1.03 at. %), with pyridinic-N being numerically the most abundant, as shown in FIG. 10. In general, pyridinic-N is interpreted as a nitrogen atom species that is located on the edge of the carbon rather than in the center. It is known that nitrogen species on the edges form excellent chemical interactions with lithium sulfide, the active material of a Li—S battery, therefore it is considered that CNT/FsEPCNF can have better electrochemical performance.

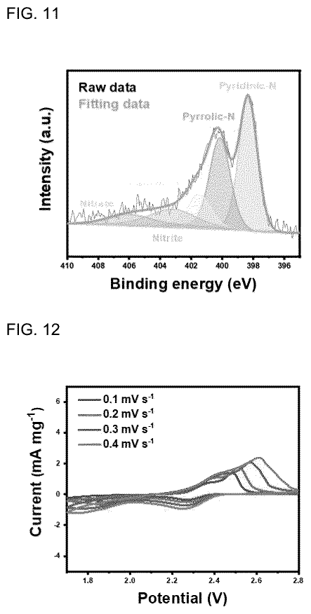

The nitrogen atom XPS analysis of the material prepared in Example 3 showed that the CCNT/FsEPCNF prepared by the introduction of transition metal precursors and carbon dioxide gas treatment had mainly pyridinic-N (1.49 at. %), pyrrolic-N (1.21 at. %), and graphitic-N (0.46 at. %), with pyridinic-N being the most abundant, as shown in FIG. 11. CCNT/FsEPCNF showed a slight decrease in the content of all nitrogen species compared to CNT/FsEPCNF. This can be interpreted as the growth of many carbon nanotubes by carbon dioxide gas, resulting in a decrease in the nitrogen ratio due to an increase in the overall carbon content.

### Example 4: Electrochemical Measurements

The materials synthesized in Examples 1, 2 and 3 were applied as positive electrodes in Li—S batteries to determine their electrochemical properties.

In Example 1, a non-porous carbon nanofiber (FsENPCNF) for self-supporting electrodes prepared using polyacrylonitrile polymer was utilized for a positive electrode of a Li—S battery. The CV analysis when the voltage was varied at different voltage scan rates within the range of 1.7 to 2.8 V exhibited that, as shown in FIG. 12, the peak shift due to overvoltage became larger as the scan rate increased.

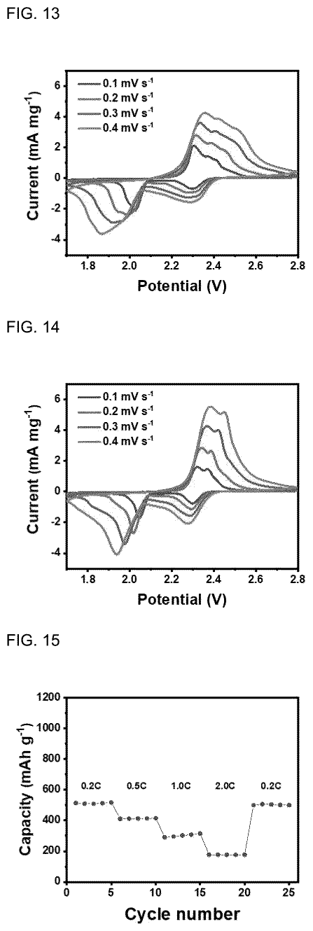

In Example 2, a carbon nanofiber with inert gas-induced carbon nanotubes (CNT/FsEPCNF) for self-supporting electrodes prepared using polyacrylonitrile polymers was utilized for a positive electrode of a Li—S battery. The CV analysis when the voltage was varied at different voltage scan rates within the range of 1.7 to 2.8 V exhibited that, as shown in FIG. 13, a larger overvoltage is generated as the scan rate increases, resulting in a shift of the peak. However, compared to the material prepared in Example 1 (FsENPCNF), the overvoltage was reduced, and the amount of current generated by the voltage change was increased. This can be attributed to the fact that the pores formed inside the carbon nanofibers and the carbon nanotubes grown on the outer surface of the carbon nanofibers uniformly distribute the active material, lithium sulfide, to promote oxidation and reduction reactions.

In Example 3, a carbon nanofiber with carbon dioxide gas-induced carbon nanotubes (CCNT/FsEPCNF) for self-supporting electrodes prepared using polyacrylonitrile polymer was utilized as a positive electrode of a Li—S battery. The CV analysis when the voltage was varied at different voltage scan rates within the range of 1.7 to 2.8 V exhibited that, as shown in FIG. 14, the overvoltage was reduced compared to the materials prepared in Examples 1 and 2, and the amount of current generated was the highest. This can be attributed to the fact that the pores formed in the carbon nanofibers and the carbon nanotubes generated in high density by carbon dioxide gas maximize the distribution of the active material, thereby increasing the utilization of lithium sulfide and further improving the oxidation and reduction reaction kinetics.

The rate capability of FsENPCNF, the material prepared using polyacrylonitrile polymer in Example 1, when utilized in a positive electrode of a Li—S battery, was tested. As shown in FIG. 15, it was run from a current density of 0.2C to a current density of 2.0C, and it can be seen that high capacity was not achieved at the lower current density, and almost no capacity was achieved at the higher current density of 2.0C.

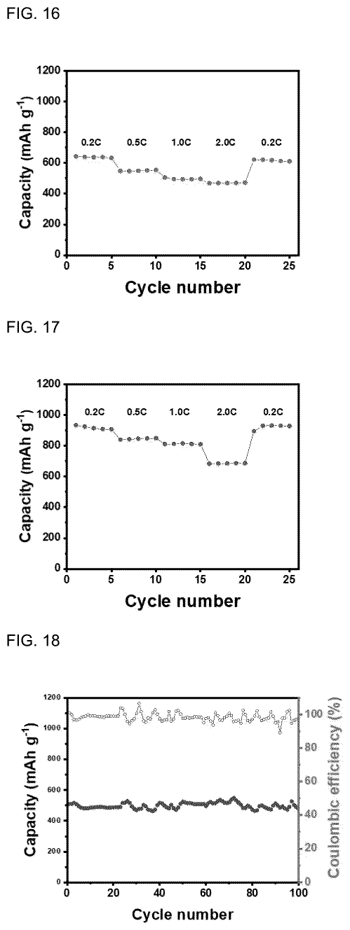

The rate capability of CNTs/FsEPCNF, the material prepared using polyacrylonitrile polymer in Example 2, when utilized in a positive electrode of a Li—S battery, was tested. As shown in FIG. 16, it was operated from a current density of 0.2 C to a current density of 2.0 C. It can be seen that although in CNT/FsEPCNF, the capacity slowly decreases as the current density increases, however it can improve capacity at all current densities compared to FsENPCNF.

The rate capability of CCNT/FsEPCNF, the material prepared using polyacrylonitrile polymer in Example 3, when utilized in a positive electrode of a Li—S battery, was tested. As shown in FIG. 17, CCNT/FsEPCNF was operated from a current density of 0.2C to a current density of 2.0C, and it had the highest capacity compared to the other two materials, which is related to the large amount of carbon nanotubes formed by carbon dioxide gas. The pores and spaces formed by the intertwined carbon nanotubes act as additional active sites for the oxidation and reduction reactions of lithium sulfide, enabling the higher capacity to be achieved.

The charge and discharge cycle capacities of the FsENPCNF, prepared using polyacrylonitrile polymer in Example 1, were measured when utilized in a positive electrode of a Li—S battery. As shown in FIG. 18, it can be seen that when driven at a rate of 0.2C, the FsENPCNF delivered a charge and discharge capacity of 510 mAh/g in the first cycle and 477 mAh/g in the 100th cycle.

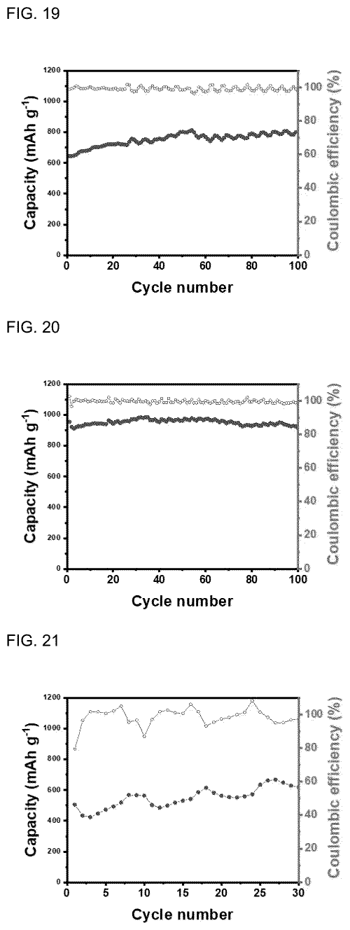

The charge and discharge cycle capacities of CNT/FsEPCNF, prepared using polyacrylonitrile polymer in Example 2, were measured when utilized in a positive electrode of a Li—S battery. As shown in FIG. 19, it can be seen that when operated at a rate of 0.2C, the CNT/FsEPCNF delivered a charge and discharge capacity of 645 mAh/g in the first cycle and 800 mAh/g in the 100th cycle. It is interpreted that the spaces inside the carbon nanofibers increase the utilization through close contact with the active material, while at the same time, the nitrogen atom species present at the edges form excellent chemical interactions with lithium sulfide, which greatly improves the electrochemical performance.

The charge and discharge cycle capacities of CCNT/FsEPCNF prepared using polyacrylonitrile polymer in Example 3 were measured when utilized in a positive electrode of a Li—S battery. As shown in FIG. 20, it can be seen that when operated at a rate of 0.2 C, it delivered a charge and discharge capacity of 954 mAh/g in the first cycle and 914 mAh/g in the 100th cycle, and had the highest electrochemical capacity compared to the two materials prepared in Examples 1 and 2. It can be interpreted that the carbon nanotubes formed from carbon dioxide gas work synergistically with the nitrogen species present at the edges to increase the utilization of the active material lithium sulfide and effectively inhibit the escape of the active material by the shuttle phenomenon, resulting in the delivery of highest capacity.

The charge and discharge cycle capacity of CCNT/FsEPCNF, prepared using polyvinylpyrrolidone polymer in Example 3, was measured when utilized in a positive electrode of a Li—S battery. As shown in FIG. 21, it delivered a charge and discharge capacity of 584 mAh/g in the first cycle and 580 mAh/g in the 16th cycle, when operated at a rate of 0.2 C.

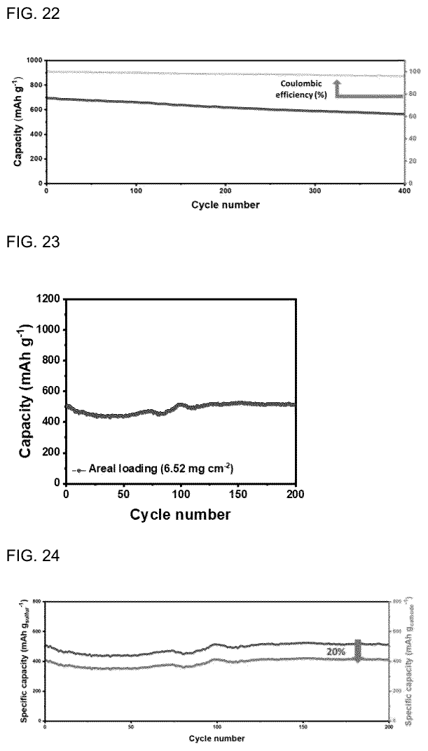

When CCNT/FsEPCNF prepared using polyacrylonitrile polymer in Example 3 was utilized as a positive electrode of a Li—S battery at a high current density of 2.0 C, the charge and discharge cycle capacity was measured shown in FIG. 22. It can be seen that the charge and discharge capacity was up to 694 mAh/g, and the discharge capacity was 565 mAh/g at the 400th cycle. The spaces inside the carbon nanofibers, the nitrogen atoms at the edges, and the carbon nanotubes grown outside of the carbon nanofibers prevented the active material lithium sulfide from escaping. Also, it accelerated the oxidation and reduction reactions, and facilitated the movement of lithium ions. The synergistic effect of these properties resulted in excellent electrochemical performance.

When CCNT/FsEPCNF prepared using polyacrylonitrile polymer in Example 3 was utilized as a positive electrode of a Li—S battery, the cycle capacity obtained by driving the cell with a high content of active material of 6.52 mg/cm² was measured, as shown in FIG. 23. It had a maximum discharge capacity of 520 mAh/g, with a discharge capacity of 513 mAh/g at the 200th cycle. It can be seen that the pores inside the carbon nanofibers, the nitrogen atoms on the edges, and the carbon nanotubes grown on the outside of the carbon nanofibers could disperse lithium sulfide uniformly, even when containing high concentrations of active materials, thus providing excellent electrochemical capacity.

CCNT/FsEPCNF prepared using polyacrylonitrile polymer in Example 3 was used as a positive electrode for a Li—S battery, and the cycle capacity graph obtained by driving a cell with a high content of active material of 6.52 mg/cm² was converted to capacity per total electrode weight. As shown in FIG. 24, when the deliverable capacity of CCNT/FsEPCNF based on the total electrode weight, it decreased by approximately 20%, and at the 200th cycle, it can achieve a discharge capacity of 412 mAh/g.

Electrodes synthesized through conventional slurries require additional materials such as electrode materials, conductive materials, and binders, resulting in a sharp decrease in the proportion of active materials and deliverable capacity when converted to capacity per total electrode weight. However, self-supporting electrodes do not require the aforementioned additional materials, maximizing the proportion of active materials and reducing the decrease in terms of deliverable capacity per total electrode weight.

While the foregoing has described in detail certain aspects of the present invention, it will be apparent to one of ordinary skill in the art that these specific descriptions are merely preferred examples and are not intended to limit the scope of the present invention. Accordingly, the substantial scope of the present invention will be defined by the claims and their equivalents.

1. A method of preparing an inert gas-induced porous carbon paper, comprising:
electrospinning a mixture of a polymeric matrix, a transition metal or transition metal oxide, and a transition metal acetylacetonate dispersed therein to obtain carbon nanofibers; and
reacting the obtained carbon nanofibers at 600° C. to 1000° C. under a bubbling process between an inert gas and an isopropyl alcohol solution to obtain a carbon paper having a structure comprising micropores (<2 nm) and mesopores (2-50 nm) simultaneously, and having carbon nanotubes grown on the carbon nanofibers.

2. The method of claim 1, wherein the polymeric matrix is a precursor for carbon nanofibers and carbon nanotubes, wherein the transition metal or transition metal oxide is a template for forming pores in the carbon nanofibers and a catalyst for growing the carbon nanotubes, and wherein the transition metal acetylacetonate is a catalyst for growing the carbon nanotubes.

3. The method of claim 1, wherein the polymeric matrix is at least one selected from the group consisting of polyacrylonitrile (PAN), polyvinylpyrrolidone (PVP), and polyvinylidene fluoride (PVDF).

4. The method of claim 1, wherein the transition metal is at least one selected from the group consisting of nickel (Ni), cobalt (Co), iron (Fe), and molybdenum (Mo).

5. The method of claim 1, wherein the transition metal oxide is at least one selected from the group consisting of NiO, Ni₂O₃, Ni₃O₄, CoO, Co₂O₃, Co₃O₄, FeO, Fe₂O₃, Fe₃O₄, MoO₂, and MoO₃.

6. The method of claim 1, wherein the transition metal acetylacetonate is at least one selected from the group consisting of nickel acetylacetonate, cobalt acetylacetonate, iron acetylacetonate, and molybdenum acetylacetonate.

7. The method of claim 1, wherein the bubbling process is performed for 30 to 120 minutes.

8. An inert gas-induced porous carbon paper prepared by the method of claim 1, having a surface area of 100-500 m²/g and a pore volume of 0.2-0.8 cm³/g.

9. A positive electrode for a Li—S battery comprising the inert gas-induced porous carbon paper of claim 8, and having a discharge capacity of 300 to 900 mAh/g for 100 cycles at 1.7 to 2.8 V and 0.2 to 2.0 C driving conditions.

10. A method of preparing a carbon dioxide gas-induced porous carbon paper, comprising:
electrospinning a mixture of a polymeric matrix, a transition metal or transition metal oxide, and a transition metal acetylacetonate dispersed therein to obtain carbon nanofibers; and
reacting the obtained carbon nanofibers at 600° C. to 1000° C. under a bubbling process between a carbon dioxide gas and an isopropyl alcohol solution dispersed with boron hydride to obtain a carbon paper having a structure comprising micropores (<2 nm) and mesopores (2-50 nm) simultaneously, and having carbon nanotubes grown on the carbon nanofibers.

11. The method of claim 10, wherein the polymeric matrix is a precursor for carbon nanofibers and carbon nanotubes, wherein the transition metal or transition metal oxide is a template for forming pores in the carbon nanofibers and a catalyst for growing the carbon nanotubes, wherein the transition metal acetylacetonate is a catalyst for growing the carbon nanotubes, and the carbon dioxide gas is a precursor for growing the carbon nanotubes.

12. The method of claim 10, wherein the polymeric matrix is at least one selected from the group consisting of polyacrylonitrile (PAN), polyvinylpyrrolidone (PVP), and polyvinylidene fluoride (PVDF).

13. The method of claim 10, wherein the boron hydride is at least one selected from the group consisting of sodium boron hydride (NaBH₄), lithium boron hydride (LiBH₄), magnesium boron hydride (Mg(BH₄)₂), strontium boron hydride (Sr(BH₄)₂), potassium boron hydride (KBH₄), and calcium boron hydride ((Ca(BH₄)₂).

14. The method of claim 10, wherein the transition metal is at least one selected from the group consisting of nickel (Ni), cobalt (Co), iron (Fe), and molybdenum (Mo).

15. The method of claim 10, wherein the transition metal oxide is at least one selected from the group consisting of NiO, Ni₂O₃, Ni₃O₄, CoO, Co₂O₃, Co₃O₄, FeO, Fe₂O₃, Fe₃O₄, MoO₂, and MoO₃.

16. The method of claim 10, wherein the transition metal acetylacetonate is at least one selected from the group consisting of nickel acetylacetonate, cobalt acetylacetonate, iron acetylacetonate, and molybdenum acetylacetonate.

17. The method of claim 10, wherein the bubbling process is performed for 30 to 120 minutes.

18. A carbon dioxide gas-induced porous carbon paper prepared by the method according to claim 10, having a surface area of 200-600 m²/g and a pore volume of 0.3-1.0 cm³/g.

19. A positive electrode for a Li—S battery comprising the carbon dioxide gas-induced porous carbon paper of claim 18, and having a discharge capacity of 500 to 1000 mAh/g for 100 cycles at 1.7 to 2.8 V and 0.2 to 2.0 C operating conditions.
